(19) United States
(12) Patent Application Publication
(10) Pub. No.: US 2025/0273919 A1
(43) Pub. Date: Aug. 28, 2025

(54) MULTI-BAND ERBIUM DOPED FIBER OPTICAL AMPLIFIER

(71) Applicant: Fujitsu Limited, Kawasaki-shi (JP)

(72) Inventor: Youichi AKASAKA, Plano, TX (US)

(73) Assignee: Fujitsu Limited, Kawasaki-shi (JP)

(21) Appl. No.: 18/590,821

(22) Filed: Feb. 28, 2024

(51) Int. Cl. H01S 3/067; H01S 3/00; H01S 3/16; H01S 3/23

(52) U.S. Cl. CPC H01S 3/06716; H01S 3/0078; H01S 3/1608; H01S 3/2316; H01S 2302/00

(57) ABSTRACT

According to an aspect of an embodiment, an erbium doped fiber amplifier (EDFA) may include a first EDFA stage configured to amplify a first wavelength range, a second wavelength range, and a third wavelength range. The EDFA may also include a filter stage configured to receive optical signals amplified by the first EDFA stage and attenuate the second wavelength range less than a gain applied to the second wavelength range by the first EDFA stage. In addition, the EDFA may include a second EDFA stage configured to receive the optical signals after the optical signals have passed through the filter stage. The second EDFA stage may also be configured to amplify the first wavelength range, the second wavelength range, and the third wavelength range.

### FIELD

The embodiments discussed in the present disclosure are related to multi-band erbium doped fiber optical amplifiers (EDFAs).

### BACKGROUND

Telecommunications systems, cable television systems and data communication networks use optical networks to convey information between remote points. In an optical network, information is conveyed in the form of optical signals through optical fibers or other optical media. The optical networks may include various components such as amplifiers, dispersion compensators, multiplexer/demultiplexer filters, wavelength selective switches, couplers, etc. configured to perform various operations within the optical network. Further, optical amplification may be used to amplify optical signals that propagate through optical networks.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, an erbium doped fiber amplifier (EDFA) may include a first EDFA stage configured to amplify a first wavelength range, a second wavelength range, and a third wavelength range. The EDFA may also include a filter stage configured to receive optical signals amplified by the first EDFA stage and attenuate the second wavelength range less than a gain applied to the second wavelength range by the first EDFA stage. In addition, the EDFA may include a second EDFA stage configured to receive the optical signals after the optical signals have passed through the filter stage. The second EDFA stage may also be configured to amplify the first wavelength range, the second wavelength range, and the third wavelength range.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates an example embodiment of a multi-band erbium doped fiber optical amplifier (EDFA);

FIG. 1B illustrates an example gain curve that may correspond to the EDFA of FIG. 1A;

FIG. 1C illustrates an example net gain profile and an example noise figure profile that may correspond to the EDFA of FIG. 1A;

FIG. 2 illustrates another example embodiment of a multi-band EDFA;

FIG. 3 is a flow chart of an example method of performing optical signal amplification using a multi-band EDFA; and

FIG. 4 illustrates a block diagram of an example computing system that may be used with multi-band EDFA, all arranged in accordance with some embodiments of the present disclosure.

### DESCRIPTION OF EMBODIMENTS

Optical networks may include nodes that may be configured to communicate information to each other via optical signals carried by optical fibers. In some circumstances, amplification of the optical signals within the optical fibers may enable the optical signals to travel a greater distance by compensating for losses that may affect the optical signal, such as degradations of the optical signal due to a noisy channel within the optical networks.

Amplification of optical signals within an optical network may be obtained using erbium doped fiber amplifiers (EDFAs) in some instances. However, the gain profile of EDF amplification may be dependent on certain wavelength bands. As such, EDFAs may be limited with respect to performing consistent amplification with respect to certain wavelength bands. For example, EDF amplification may vary between the C-band of optical communications (e.g., frequencies having wavelengths approximately between 1525 nanometers (nm) and 1565 nm), the L-band of optical communications (e.g., frequencies having wavelengths approximately between 1565 nm and 1605 nm), and the S-band of optical communications (e.g., frequencies having wavelengths approximately between 1485 nm and 1525 nm). Such variations have made it difficult to use an EDFA for amplification for optical signals that include all of these communication bands.

For example, EDFAs may amplify the C-band significantly more than the S-band and/or the L-band. Additionally or alternatively, the C-band amplification may be such that the overall optical signal is saturated after amplification such that additional amplification of the S-band and/or the L-band may be reduced or prevented.

According to one or more embodiments of the present disclosure, a multi-band EDFA may be configured in a manner to allow for amplification of multiple wavelength bands that may have been previously limited. In particular, as described in detail in the present disclosure, the multi-band EDFA may include one or more EDFA stages and one or more filter stages that may follow the respective EDFA stages. The filter stages may be configured to attenuate a particular wavelength range (e.g., the C-band) that is amplified significantly more than the other wavelength ranges by the EDFA stages such that the resulting gain applied to the particular wavelength range may allow for amplification of the other wavelength ranges. Such a configuration may allow for the EDFA to operate as a multi-band amplifier with respect to one or more wavelength ranges for which EDF amplification has traditionally been ill suited.

Embodiments of the present disclosure will be explained with reference to the accompanying drawings.

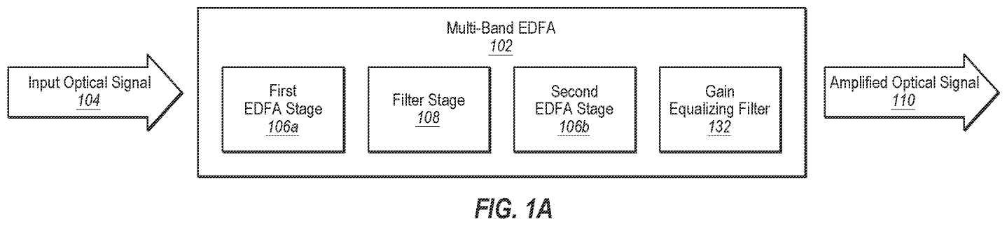

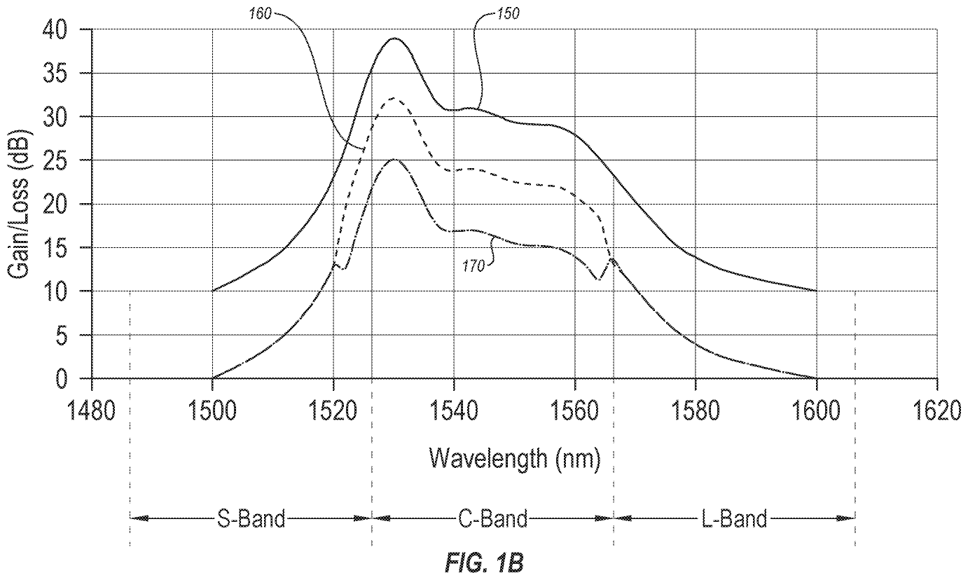

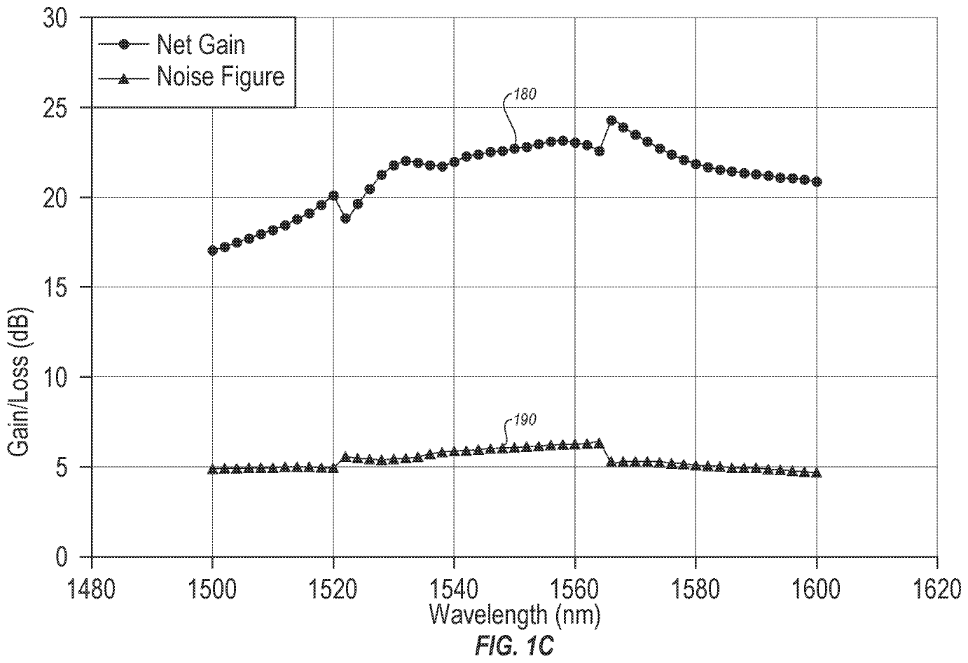

FIG. 1A illustrates an example embodiment of a multi-band EDFA 102, in accordance with at least one embodiment of the present disclosure. In general, the EDFA 102 may be configured to amplify an optical signal 104 to generate an amplified optical signal 110. The EDFA 102 may be included in any suitable optical device or network.

The optical signal 104 may include any optical signal configured to carry data. For example, the optical signal 104 may include an optical signal generated by a light emitting diode (LED), a laser such as a laser diode, having data modulated thereon and/or other similar optical signals. In some embodiments, the optical signal 104 may be generated by a transmitting source, such as an optical transmitter, configured to convey data and/or information over an optical network.

In some embodiments, the optical signal 104 may include a wavelength division multiplexing (WDM) signal that may include multiple beams that each correspond to different wavelength ranges. Additionally or alternatively, the different wavelength ranges may correspond to different optical signal communication bands.

For example, in some embodiments, the optical signal 104 may include a first sub-signal corresponding to a first wavelength range, a second sub-signal corresponding to a second wavelength range, a third sub-signal corresponding to a third wavelength range, and/or a fourth sub-signal corresponding to a fourth wavelength range. In some embodiments, the first wavelength range may correspond to what may be commonly referred to as the C-band of optical signal communications, which may be approximately 1525 nm to 1565 nm. In these and other embodiments, the second wavelength range may correspond to what may be commonly referred to as the L-band of optical signal communications, which may be approximately 1565 nm to 1610 nm. Additionally or alternatively, the third wavelength range and the fourth wavelength range may correspond to one or more bands that may be outside of the C-band or the L-band. For example, the third wavelength range may correspond to what may be commonly referred to as the S-band of optical signal communications, which may be approximately 1410 nm to 1500 nm. Additionally or alternatively, the fourth wavelength range may correspond to what may be commonly referred to as the U-band of optical signal communications, which may be approximately 1610 nm to 1720 nm.

In these and other embodiments, the optical signal 104 may have one or more polarization states. For example, in some embodiments, one or more sub-signals of the optical signal 104 may be oriented according to a first polarization and one or more sub-signals of the optical signal 104 may be oriented according to a second polarization. In these and other embodiments, the first polarization may be orthogonal to the second polarization. For example, the first polarization may correspond to an x-polarization and the second polarization may correspond to a y-polarization that is perpendicular to the x-polarization.

In some embodiments, the EDFA 102 may include a first EDFA stage 106a and a second EDFA stage 106b. The EDFA stages 106 may be individually configured to provide a gain to the optical signal 104 such that the power of the optical signal 104 may increase in a cumulative manner as the optical signal 104 passes through the EDFA stages 106.

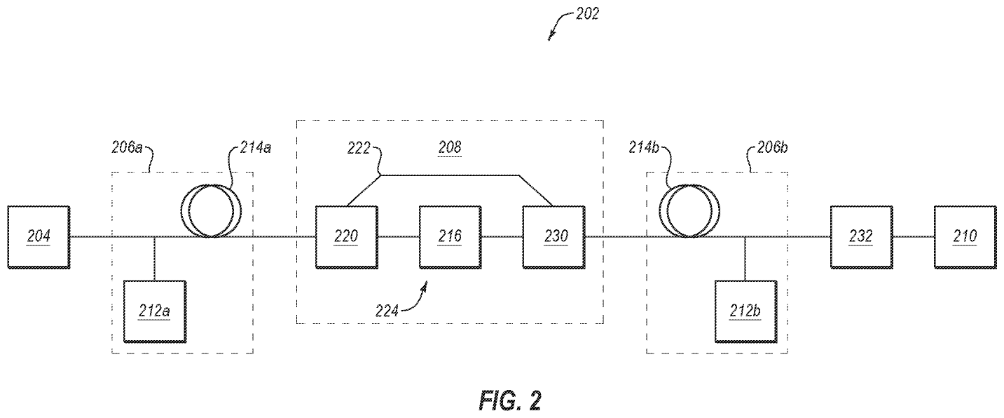

For example, the first EDFA stage 106a may be the initial EDFA stage that receives and amplifies the optical signal 104 and the second EDFA stage 106b may be the next EDFA stage after the first EDFA stage 106a and may apply additional amplification to the optical signal 104 after amplification by the first EDFA stage 106a. Although illustrated as including two EDFA stages 106, the EDFA 102 may include any number of EDFA stages depending on the particular implementation. Further examples and descriptions that may correspond to one or more embodiments of the EDFA stages 106 are given in further detail with respect to FIG. 2.

In some embodiments, the amount of gain that is provided by the first EDFA stage 106a may vary for different wavelength ranges. For example, FIG. 1B illustrates an example gain profile 150 that may correspond to the first EDFA stage 106a and/or the second EDFA stage 106b. As illustrated in FIG. 1B, the gain for the second wavelength range corresponding to the C-band (e.g., wavelengths approximately between 1525 and 1565 nm) may be significantly greater than for the first wavelength range corresponding to the S-band (e.g., wavelengths approximately between 1485 nm and 1525 nm). Further, as also illustrated in FIG. 1B, the gain for the second wavelength range corresponding to the C-band may be significantly greater than for the third wavelength range corresponding to the L-band (e.g., wavelengths approximately between 1565 nm and 1605 nm).

Returning to FIG. 1A, the EDFA 102 may also include a filter stage 108. The filter stage 108 may be inserted between EDFA stages. For example, in some embodiments, the filter stage 108 may be disposed between the first EDFA stage 106a and the second EDFA stage 106b, such as illustrated in FIG. 1A. In instances in which the EDFA 102 includes additional EDFA stages, a filter stage similar or analogous to the filter stage 108 may be disposed between preceding and following EDFA stages. For example, in instances where the EDFA 102 were to include a third EDFA stage following the second EDFA stage 106b, another filter stage may be disposed between the second EDFA stage 106b and the third EDFA stage.

The filter stage 108 may be configured to attenuate a particular wavelength band as compared to one or more other wavelength bands that may correspond to the optical signal 104. Additionally or alternatively, the particular wavelength band may correspond to a wavelength band that is most amplified by the first EDFA stage 106a.

For example, as illustrated by FIG. 1B, in some embodiments the first EDFA stage 106a may amplify the second wavelength range (e.g., the C-band) significantly more than the first wavelength range (e.g., the S-band) and/or the third wavelength range (e.g., the L-band). As such, the filter stage 108 may be configured to attenuate the second wavelength range while avoiding significant attenuation of the first wavelength range and/or the third wavelength range. Note that in some instances, the first wavelength range and/or the third wavelength range may experience at least some attenuation while passing through the filter stage 108. However, the amount of attenuation experienced by these wavelength ranges due to the filter state 108 may be less than that experienced by the second wavelength range due to the filter stage 108. Further examples and descriptions that may correspond to one or more embodiments of the filter stage 108 are given in further detail with respect to FIG. 2.

In some embodiments, the amount of attenuation that may be applied to the second wavelength range may be based on one or more attenuation factors. For example, the target amount of attenuation for the second wavelength range may be set as not being greater than the amount of gain applied to the second wavelength range by the first EDFA stage 106a. In such an embodiment, at least some gain may be attained for the second sub-signals corresponding to the second wavelength range after the optical signal 104 has passed through the first EDFA stage 106a and the filter stage 108.

Additionally or alternatively, the amount of attenuation may be based on a difference between the noise figure and the gain applied to the second wavelength range by the first EDFA stage 106a. For instance, to avoid signal loss, the amount of attenuation may be set as being less than the gain minus the noise figure such that a net gain of the second wavelength range is greater than the noise figure. For example, the amount of gain applied to the second wavelength range by the first EDFA stage 106a may be 35 dB and the noise figure corresponding to the first EDFA stage 106a may be 7 dB. As such, the amount of attenuation may be set as being less than 28 dB to avoid losing the second sub-signals corresponding to the second wavelength in the noise.

In these and other embodiments, the amount of attenuation for the second wavelength range may be based on an amount of gain that may be applied by the first EDFA stage 106a to the first wavelength range and/or the third wavelength range. For example, in some embodiments, the target net gain (e.g., gain minus attenuation) of the second wavelength range may be based on the net gain of the second wavelength being relatively close to the gain applied to the first wavelength range after amplification by the first EDFA stage 106a and/or the gain applied to the third wavelength range after amplification by the first EDFA stage 106a.

For example, as illustrated by the gain profile 150 in FIG. 1B, a lower amount of gain that may be applied to certain wavelengths within the first and third wavelength ranges may be 10 dB. In some embodiments, the amount of attenuation may be such that the net gain for the second wavelength is around 10 dB. For example, in instances in which a gain of 35 dB is applied to the second wavelength, the amount of attenuation may be around 25 dB (as long as the net gain is above the noise figure).

FIG. 1B also illustrates an example attenuation profile 160 that may indicate the amount of attenuation that may be applied by the filter stage 108 with respect to various wavelength ranges. As illustrated in FIG. 1B, the attenuation profile 160 may be shaped similarly to the gain profile 150.

In some embodiments, the EDFA 102 may include a gain equalizing filter 132 that is disposed after the second EDFA stage 106b. The gain equalizing filter 132 may include any suitable component that is configured to equalize, after amplification by the second EDFA stage 106b, a first cumulative gain corresponding to the first wavelength range, a second cumulative gain corresponding to the second wavelength range; and a third cumulative gain corresponding to the third wavelength range.

For example, in some embodiments, the gain equalizing filter 132 may be configured to attenuate the different wavelength ranges based on respective power levels of such wavelength ranges after passing through the second EDFA stage 106b (“output power”) and target power levels for the respective wavelength ranges (“target power”). For instance, the gain equalizing filter 132 may be configured such that the amount of attenuation for each respective wavelength range may be “output power-target power”, where the output power and the target power corresponding to the respective wavelength ranges. FIG. 1B also illustrates an example attenuation profile 170 that may indicate the amount of attenuation that may be applied by the gain equalizing filter 132 with respect to various wavelength ranges. As illustrated in FIG. 1B, the attenuation profile 170 may be shaped similarly to the gain profile 150 and the attenuation profile 160.

The signal that is output after the gain equalizing filter 132 may be the amplified optical signal 110, which may be an amplified version of the optical signal 104 received at the first EDFA stage 106a as cumulatively amplified by the EDFA 102 via the first EDFA stage 106a, and the second EDFA stage 106b, with the gain adjustments as provided by the filter stage 108 and the gain equalizing filter 132.

The net result of application of the gains applied by the EDFA stages and the attenuations applied by the filter stage 108 and the gain equalizing filter 132 may be such that net gain applied across the different wavelength ranges of the optical signal 104 may be relatively equal while also keeping changes to the noise figure relatively the same across the different wavelength ranges, as compared to other optical amplifiers. FIG. 1C illustrates an example net gain profile 180 that may indicate the amount of net gain that may be applied by the EDFA 102 with respect to various wavelength ranges. Further, FIG. 1C illustrates an example noise figure profile 190 corresponding to the EDFA 102.

Modifications, additions, or omissions may be made to FIGS. 1A-1C without departing from the scope of the present disclosure. For example, as indicated above, the number of EDFA stages and/or filter stages included in different embodiments of the multi-band EDFA 102 may vary. For instance, in some embodiments, the multi-band EDFA may include a second filter stage and a third EDFA stage in which the second filter stage may be disposed between the second EDFA stage 106b and the third EDFA stage. Additionally or alternatively, in such embodiments, the third EDFA stage may be disposed between the second filter stage and the gain equalizing filter 132. Further, the gain and/or attenuation profiles illustrated in FIGS. 1B and 1C may correspond to targeted profiles such that actual profiles may vary. Additionally or alternatively, the gain and/or attenuation profiles illustrated in FIGS. 1B and 1C may be based on embodiments of the EDFA 102 having a different number of EDFA stages than explicitly indicated in FIG. 1A. For instance, FIG. 1C may correspond to embodiments in which the EDFA 102 includes three EDFA stages 106.

Further, the EDFA stages 106 may have similar to the same configurations and/or one or more EDFA stages 106 may differ. For example, as discussed in further detail below, in some embodiments, one or more EDFA stages 106 may include respective pump sources. In these and other embodiments, the wavelengths corresponding to two or more of the pump sources may be the same or may vary. The selections of the different pump sources may be based on noise and/or gain profiles. Example embodiments are described in further detail with respect to FIG. 2.

In these and other embodiments, the EDFA 102 may include one or more other elements not expressly illustrated or described. For example, in some embodiments, the EDFA 102 may include one or more other optical amplifiers and/or filters than those expressly discussed.

Additionally or alternatively, the EDFA 102 may be configured for specific wavelength ranges. For example, in some embodiments, the EDFA 102 may be configured to provide amplification to frequencies that correspond to the C-band, the L-band, and the S-band, such as described above and in more detail with respect to FIG. 2. Additionally or alternatively, the EDFA 102 may be configured to provide amplification to wavelengths that correspond to other bands. For instance, the EDFA 102 may be configured to provide amplification to one or more other optical communication bands than those specifically discussed (e.g., the U-band).

FIG. 2 illustrates an example embodiment of a multi-band EDFA 202 (“EDFA 202”), in accordance with at least one embodiment of the present disclosure. In general, the EDFA 202 may be configured to amplify an optical signal 204 to generate an amplified optical signal 210 and may be an example of the EDFA 102 of FIG. 1A. In some embodiments, the optical signal 204 may be a WDM signal having multiple sub-signals that correspond to different frequency and corresponding wavelength ranges, such as the optical signal 104 of FIG. 1. For example, the optical signal 204 may include a first sub-signal corresponding to a first wavelength range (e.g., the S-band), a second sub-signal corresponding to a second wavelength range (e.g., the C-band), and a third sub-signal corresponding to a third wavelength range (e.g., the L-band).

Additionally or alternatively, the amplified optical signal 210 may be similar or analogous to the amplified optical signal 110 of FIG. 1A. The EDFA 202 may be included in any suitable optical device or network. Additionally or alternatively, the EDFA 202 may be configured as a C-band, L-band, and S-band amplifier (“S-C-L amplifier”), as detailed below.

In some embodiments, the EDFA 202 may include a first EDFA stage 206a. The first EDFA stage 206a may illustrate an example implementation of the first EDFA stage 106a of FIG. 1A.

The first EDFA stage 206a may be configured to receive the optical signal 204 and direct the optical signal 204 toward a first EDF 214a. The first EDF 214a may be an erbium-doped optical fiber that is includes erbium ions embedded therein. The erbium ions may become excited by a pumping beam that may be injected into the first EDF 214a via a pump source 212a. When the erbium ions are excited by the pumping beam, they absorb energy and move to higher energy levels. As these excited erbium ions return to their lower energy states, they release energy in the form of photons at longer wavelengths, which may then provide amplification to the optical signal 104 that is travelling through the first EDF 214a.

In some embodiments, the first EDF 214a may have a certain length that may correspond to a target amount of gain and/or gain bandwidth. The particular type of EDF (e.g., the Er dopant concentration) may also be such that the amount of gain and/or gain bandwidth may vary for the same length of different types of EDFs. Additionally or alternatively, the amount of gain and/or the gain bandwidth may vary for different lengths and/or EDF types depending on the pumping beam wavelength. As such, such factors may be considered and/or modified to achieve a target amount of gain and/or to achieve a target gain bandwidth. For example, the first EDF 214a may have a length of 2.5 meters, which may be based on the type of EDF and the target amount of amplification for the first EDFA stage 206a.

In some embodiments, the pump source 212a may include a light source generator that may be configured to produce the pumping beam. For example, the pump source 212a may include a laser device that may be configured to produce and/or output the pumping beam.

The pump source 212a may be configured to generate the pumping beam to have a particular wavelength (also referred to as operating at the particular wavelength). The particular wavelength may be selected based on one or more amplification effects that may correspond to certain wavelengths. For example, a pumping beam corresponding to a 980 nm wavelength may have relatively good noise performance (e.g., may not create lots of noise) but may provide a more limited gain. By contrast, a pumping beam corresponding to a 1480 nm wavelength may have worse noise performance as compared to a 980 nm wavelength but may provide greater gain. In the present example of FIG. 2, the pumping wavelength corresponding to the pump source 212a may be 980 nm, which may also be referred to as the pump source 212a operating at a pumping wavelength of 980 nm. Such a selection may be based on balancing not introducing noise into the optical signal early in the amplification provided by the EDFA 202 to reduce the amount of noise that may be amplified by later stages of the EDFA 202.

In these and other embodiments, the pump source 212a may be configured such that the resulting pumping beam may be a high-power pumping beam. For example, the pumping beam may include a power of at least 20 decibel-milliwatts (dBm).

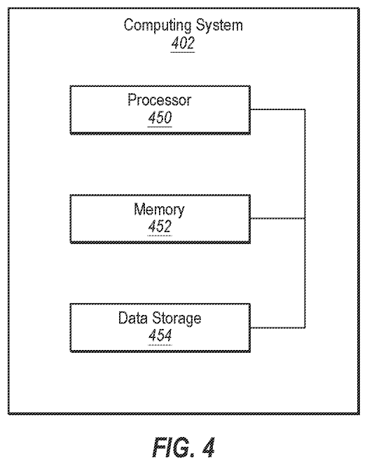

Additionally or alternatively, in some embodiments, the pump source 212a may be controlled using a computing system such as the computing system described below with respect to FIG. 4 of the present disclosure. For example, the computing system may be used to control or select the wavelength corresponding to the pumping beam.

In some embodiments, the EDFA 202 may include a filter stage 208, which may be an example implementation of the filter stage 108 of FIG. 1A. As discussed with respect to FIGS. 1A and 1B, in some embodiments, the filter stage 208 may be configured to attenuate the second wavelength range while avoiding significant attenuation of the first wavelength range and/or the third wavelength range.

For example, the filter stage 208 may include a demultiplexer 220. The demultiplexer 220 may be configured to separate the first sub-signal of the optical signal 204 corresponding to the first wavelength range from the second sub-signal of the optical signal 204 corresponding to the second wavelength range and the third sub-signal of the optical signal 204 corresponding to the third wavelength range.

In these and other embodiments, the filter stage 208 may include a first optical path 222 optically coupled to the demultiplexer 220. The first optical path 222 may bypass a filter 216 included in the filter stage 208. In these and other embodiments, the first optical path 222 may be configured to receive the third sub-signal (which may correspond to the third wavelength range (e.g., the L-band)) such that the third sub-signal bypasses any attenuating that may be performed by the filter 216.

Additionally or alternatively, the filter stage 208 may include a second optical path 224 also optically coupled to the demultiplexer 220. The second optical path 224 may be configured to receive the second and third sub-signals. Additionally or alternatively, the second optical path 224 may include the filter 216 such that the filter 216 receives the first and second sub-signals.

The filter 216 may include any suitable component that is configured to filter out certain wavelengths in some embodiments. For example, in some embodiments, the filter 216 may be configured as a low-pass filter that attenuates the second wavelength range and the third wavelength range, but that allows the first wavelength range to pass through without significant attenuation (e.g., less than 3 dB of attenuation of the first wavelength range). Further, the filter 216 may be configured such that it may attenuate the third wavelength range more than the second wavelength range. As indicated above, attenuation of the third wavelength range (and corresponding signals such as the third sub-signal) may want to be avoided. As such, the first optical path 222 having the third sub-signal directed thereto may bypass the filter 216.

In these and other embodiments, the filter 216 may be configured such that the attenuation of the second wavelength range corresponds to a target amount of attenuation. For example, the filter 216 may be configured such that the amount of attenuation is based on one or more of a noise figure, a total amount of gain provided to the second wavelength range by the first EDFA stage 206a, a total amount of gain provided to the first wavelength range by the first EDFA stage 206a, a total amount of gain provided to the third wavelength range by the first EDFA stage 206a, etc., such as described above with respect to FIGS. 1A and 1B.

In some embodiments, the filter 216 may be a static filter that may have a fixed frequency response. Reference to a “fixed frequency response” accounts for unintended drift of the frequency response due to certain conditions and is meant to convey a frequency response that is not readily adjustable and is not meant to refer to a frequency response that is absolutely unmoving. Additionally or alternatively, the filter 216 may be a dynamic filter that may have an adjustable frequency response. In some embodiments, one or more of the adjustment operations may be performed or directed by a computing system such as that described with respect to FIG. 4.

The filter stage 208 may include a multiplexer 230 in some embodiments. The multiplexer 230 may be disposed after the filter 216 such as illustrated and may be optically coupled to the first optical path 222 and the second optical path 224. The multiplexer 230 may be configured to recombine the third sub-signal with the first and second sub-signals after the first and second sub-signals pass through the filter 216.

The above-described configuration of the filter stage 208 may accordingly be configured to avoid attenuation of the third sub-signal by having the third sub-signal bypass the filter 216. Further, the above-described configuration of the filter stage 208 may also be configured to avoid attenuation of the first sub-signal, by configuring the filter 216 to allow the first sub-signal to pass through it without significant attenuation. Further, the above-described configuration of the filter stage 208 may be configured to attenuate the second sub-signal such that the net gain of the second sub-signal after passing through the first EDFA stage 206a and the filter stage 208 is relatively similar to that of the first and third sub-signals also after having passed through the first EDFA stage 206a and the filter stage 208.

In the illustrated example, the recombined optical signal may be received by the second EDFA stage 206b. The second EDFA stage 206b may include a second EDF 214b that may be similar or analogous to the first EDF 214a of the first EDFA stage 206a. In these and other embodiments, the second EDF 214b may be a substantially same length as the first EDF 214a. Additionally or alternatively, the second EDF 214b may have a different length than the first EDF 214a. For example, in some embodiments, the second EDF 214b may have a length of 3 meters while the first EDF 214a may have a length of 2.5 meters. The length difference may correspond to different target gains and/or gain bandwidths for the first EDFA stage 206a and the second EDFA stage 206b and/or may correspond to different types of EDFs being used for the two stages.

In these and other embodiments, the second EDFA stage 206b may include a pump source 212b that may be similar or analogous to the pump source 212a. In some embodiments, the wavelength corresponding to the pump source 212b may be the same as that corresponding to the pump source 212a. For example, as illustrated, both the pump source 212a and the pump source 212b may generate respective pumping beams corresponding to 980 nm. Additionally or alternatively, the wavelength corresponding to the pump source 212a and the pump source 212b may differ. For example, the pump source 212b may generate a pumping beam corresponding to 1480 nm.

After amplification by the second EDFA stage 206b, the optical signal may be received at a gain equalizing filter 232. The gain equalizing filter 232 may be substantially similar or analogous to the gain equalizing filter 132 described with respect to FIGS. 1A and 1B.

For example, the gain equalizing filter 232 may be configured to filter the optical signal such that the power of the optical signal across the different communication bands (e.g., the C-band, the L-band, and the S-band) is substantially the same. The signal that is output after the gain equalizing filter 232 may be the amplified optical signal 210, which may be an amplified version of the optical signal 204 received at the first EDFA stage 206a as cumulatively amplified by the EDFA 202 via the first EDFA stage 206a, and the second EDFA stage 206b, with the gain adjustments as provided by the filter stage 208 and the gain equalizing filter 232.

Modifications, additions, or omissions may be made to the EDFA 202 without departing from the scope of the present disclosure. For example, as indicated above, the number of EDFA stages and/or filter stages included in different embodiments of the EDFA 202 may vary. Further, the EDFA stages 206 may have similar to the same configurations and/or one or more EDFA stages 206 may differ. Further, the EDFA 202 may include one or more other components that help facilitate the propagation and/or manipulation of the optical signal to obtain the targeted amount of gain. Further, the wavelengths corresponding to the different pump sources, the specific types of optical fibers used, and/or the lengths of different optical fibers may vary depending on specific implementations and design goals.

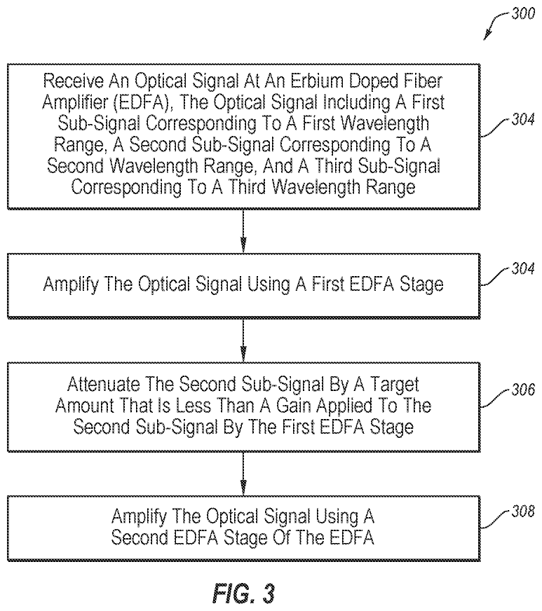

FIG. 3 is a flow chart of an example method 300 of performing amplification with respect to an optical signal using a multi-band EDFA, arranged in accordance with at least one embodiment of the present disclosure. One or more operations of the method 300 may be implemented by any suitable element of a multi-band EDFA such as the multi-band EDFA 102 of FIG. 1A and/or the multi-band EDFA 202 of FIG. 2. Although illustrated as discrete steps, various steps of the method 300 may be divided into additional steps, combined into fewer steps, or eliminated, depending on the desired implementation. Additionally, the order of performance of the different steps may vary depending on the desired implementation.

In some embodiments, the method 300 may include a block 302. At block 302, an optical signal may be received at an EDFA. In some embodiments, the optical signal may include a first sub-signal corresponding to a first wavelength range (e.g., the S-band), a second sub-signal corresponding to a second wavelength range (e.g., the C-band), and a third sub-signal corresponding to a third wavelength range (e.g., the L-band). It is also noted that although referred to as “sub-signals” the first sub-signal, the second sub-signal, and the third sub-signal may also just be referred to as “signals”. The optical signal 104 of FIG. 1A or the optical signal 204 of FIG. 2 may be examples of the optical signal and the EDFA 102 of FIG. 1A or the EDFA 202 of FIG. 2 may be examples of the EDFA.

At block 304, the optical signal (including the first sub-signal, the second sub-signal, and/or the third sub-signal) may be amplified using a first EDFA stage of the EDFA. The first EDFA stage 106a of FIG. 1A and the first EDFA stage 206a of FIG. 2 may be examples of the first EDFA stage. Further, the gain profile of FIG. 1B may illustrate an example of how the different sub-signals may be amplified.

At block 306, the second sub-signal may be attenuated by a target amount that is less than a gain applied to the second sub-signal by the first EDFA stage. The attenuation may be performed by a filter stage configured to receive the optical signal after amplification by the first EDFA stage. In some embodiments, the amount of attenuation applied by the filter stage to the second sub-signal may be based on an amount of gain applied by the first EDFA stage to the second wavelength range, such as described above with respect to FIG. 1A. Additionally or alternatively, the amount of attenuation applied by the filter stage to the second sub-signal may be based on a noise figure corresponding to the first EDFA stage, such as described above with respect to FIG. 1A. In these and other embodiments, the amount of attenuation applied by the filter stage to the second sub-signal may be based on an amount of gain applied by the first EDFA stage to the first sub-signal and/or the second sub-signal such as described above with respect to FIG. 1A.

In some embodiments, the filter stage 108 of FIG. 1A or the filter stage 208 of FIG. 2 may be examples of the filter stage. For example, in some embodiments, the filter stage may include a bypass path configured to receive the third sub-signal and configured to bypass and optical filter of the filter stage, such as described above with respect to FIG. 2. Additionally or alternatively, the optical filter may be configured to receive the first and second sub-signals. In these and other embodiments, the optical filter may allow the first sub-signal to pass through it—e.g., not attenuate the first sub-signal more than a threshold amount (e.g., not attenuate the first sub-signal more than 3 dB). Additionally or alternatively, the optical filter may be configured to attenuate the second sub-signal by the target amount of attenuation for the second sub-signal.

The passing through of the first sub-signal may be based on the optical filter being configured to allow the first wavelength range corresponding to the first sub-signal to pass through it. Further, the attenuation of the second sub-signal by the optical filter may be based on the optical filter being configured to attenuate the second wavelength range corresponding to the second sub-signal by the target amount of attenuation.

In these and other embodiments, block 306 may include separating the third sub-signal from the first and second sub-signals to allow the third sub-signal to pass through the bypass path. In some embodiments, the separation may be performed using a demultiplexer such as described above with respect to FIG. 2.

Additionally or alternatively, following the passing of the first and second sub-signals through the optical filter and the third sub-signal through the bypass path, block 306 may include recombining the first, second, and third sub-signals. In some embodiments, the recombining may be performed using a multiplexer such as described above with respect to FIG. 2.

At block 308, the optical signal (including the first sub-signal, the second sub-signal, and/or the third sub-signal) may be amplified using a second EDFA stage of the EDFA. Such amplification may occur after the optical signal has passed through the filter stage (e.g., after attenuation of the second sub-signal by the filter stage). The second EDFA stage 106b of FIG. 1A and the second EDFA stage 206b of FIG. 2 may be examples of the second EDFA stage. Further, the gain profile of FIG. 1B may illustrate an example of how the different sub-signals may be amplified.

Modifications, additions, or omissions may be made to the method 300 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

Additionally or alternatively, in some embodiments, For example, as indicated above, the number of EDFA stages and/or filter stages included in different embodiments of the multi-band EDFA may vary. Further, the EDFA stages may have similar to the same configurations and/or one or more EDFA stages may differ.

In these and other embodiments, the method may include other operations such as equalizing, after amplification by the second EDFA stage, a first cumulative gain corresponding to the first sub-signal, a second cumulative gain corresponding to the second sub-signal, and a third cumulative gain corresponding to the third sub-signal. In these and other embodiments, the cumulative gains of the respective sub-signals may correspond to aggregation of the gains applied by the first EDFA stage and the second EDFA stage to the respective sub-signals minus attenuation that may be applied by the filter stage. In some embodiments, the gain equalizing may be performed by a gain equalizing filter such as the gain equalizing filter 232 of FIG. 2.

FIG. 4 illustrates a block diagram of an example computing system 402 that may be used with respect to a multi-band EDFA, according to at least one embodiment of the present disclosure. For example, the computing system 402 may be used to adjust a pumping wavelength of a pump source of the EDFA (e.g., one or more of the pump sources described above) and/or a frequency response of a filter of the EDFA (e.g., one or more of the filters described above).

The computing system 402 may include a processor 450, a memory 452, and a data storage 454. The processor 450, the memory 452, and the data storage 454 may be communicatively coupled.

In general, the processor 450 may include any suitable special-purpose or general-purpose computer, computing entity, or processing device including various computer hardware or software modules and may be configured to execute instructions stored on any applicable computer-readable storage media. For example, the processor 450 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, the processor 450 may include any number of processors configured to, individually or collectively, perform or direct performance of any number of operations described in the present disclosure. Additionally, one or more of the processors may be present on one or more different electronic devices, such as different servers.

In some embodiments, the processor 450 may be configured to interpret and/or execute program instructions and/or process data stored in the memory 452, the data storage 454, or the memory 452 and the data storage 454. In some embodiments, the processor 450 may fetch program instructions from the data storage 454 and load the program instructions in the memory 452. After the program instructions are loaded into memory 452, the processor 450 may execute the program instructions.

The memory 452 and the data storage 454 may include computer-readable storage media for carrying or having computer-executable instructions or data structures stored thereon. Such computer-readable storage media may include any available media that may be accessed by a general-purpose or special-purpose computer, such as the processor 450. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 450 to perform a certain operation or group of operations.

Modifications, additions, or omissions may be made to the computing system 402 without departing from the scope of the present disclosure. For example, in some embodiments, the computing system 402 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. An erbium doped fiber amplifier (EDFA) comprising:
a first erbium doped fiber amplifier (EDFA) stage configured to amplify a first wavelength range, a second wavelength range, and a third wavelength range;
a filter stage configured to:
receive optical signals amplified by the first EDFA stage; and
attenuate the second wavelength range less than a gain applied to the second wavelength range by the first EDFA stage; and
a second EDFA stage configured to:
receive the optical signals after the optical signals have passed through the filter stage; and
amplify the first wavelength range, the second wavelength range, and the third wavelength range.

2. The EDFA of claim 1, wherein:
the first wavelength range corresponds to an S-band of optical communications;
the second wavelength range corresponds to a C-band of optical communications; and
the third wavelength range corresponds to an L-band of optical communications.

3. The EDFA of claim 1, wherein the filter stage includes an optical filter configured to:
allow the first wavelength range to pass through it; and
attenuate the second wavelength range and the third wavelength range.

4. The EDFA of claim 3, wherein:
the optical filter is further configured to:
receive a first optical signal corresponding to the first wavelength range; and
receive a second optical signal corresponding to the second wavelength range; and
the filter stage includes a bypass path configured to:
receive a third optical signal corresponding to the third wavelength range; and
bypass the optical filter such that the third optical signal avoids passing through the optical filter.

5. The EDFA of claim 1, further comprising a gain equalization filter configured to equalize, after amplification by the second EDFA stage, a first cumulative gain corresponding to the first wavelength range, a second cumulative gain corresponding to the second wavelength range, and a third cumulative gain corresponding to the third wavelength range.

6. The EDFA of claim 1, wherein an amount of attenuation applied by the filter stage to the second wavelength range is based on an amount of gain applied by the first EDFA stage to the second wavelength range.

7. The EDFA of claim 1, wherein an amount of attenuation applied by the filter stage to the second wavelength range is based on a noise figure corresponding to the first EDFA stage.

8. The EDFA of claim 1, wherein an amount of attenuation applied by the filter stage to the second wavelength range is based on an amount of gain applied by the first EDFA stage to the first wavelength range.

9. The EDFA of claim 1, wherein an amount of attenuation applied by the filter stage to the second wavelength range is based on an amount of gain applied by the first EDFA stage to the third wavelength range.

10. A method comprising:
receiving an optical signal at a multi-band erbium doped fiber amplifier (EDFA), the optical signal including a first sub-signal corresponding to a first wavelength range, a second sub-signal corresponding to a second wavelength range, and a third sub-signal corresponding to a third wavelength range;
amplifying the first sub-signal, the second sub-signal, and the third sub-signal using a first EDFA stage of the multi-band EDFA;
attenuating, using a filter stage of the multi-band EDFA, the second sub-signal less than a gain applied to the second sub-signal by the first EDFA stage; and
after attenuation of the second sub-signal, amplifying the first sub-signal, the second sub-signal, and the third sub-signal using a second EDFA stage of the multi-band EDFA.

11. The method of claim 10, wherein:
the first wavelength range corresponds to an S-band of optical communications;
the second wavelength range corresponds to a C-band of optical communications; and
the third wavelength range corresponds to an L-band of optical communications.

12. The method of claim 10, wherein the filter stage includes an optical filter configured to:
allow the first wavelength range to pass through it; and
attenuate the second wavelength range and the third wavelength range.

13. The method of claim 12, wherein:
the optical filter is further configured to receive the first sub-signal and the second-sub-signal. and
the filter stage includes a bypass path configured to:
receive the third sub-signal; and
bypass the optical filter such that the third sub-signal avoids passing through the optical filter.

14. The method of claim 10, wherein an amount of attenuation applied by the filter stage to the second sub-signal is based on an amount of gain applied by the first EDFA stage to the second wavelength range.

15. The method of claim 10, wherein an amount of attenuation applied by the filter stage to the second sub-signal is based on a noise figure corresponding to the first EDFA stage.

16. The method of claim 10, wherein an amount of attenuation applied by the filter stage to the second sub-signal is based on an amount of gain applied by the first EDFA stage to the first sub-signal.

17. The method of claim 10, wherein an amount of attenuation applied by the filter stage to the second wavelength range is based on an amount of gain applied by the first EDFA stage to the third wavelength range.

18. An erbium doped fiber amplifier (EDFA) comprising:
a first erbium doped fiber amplifier (EDFA) stage configured to amplify a first wavelength range, a second wavelength range, and a third wavelength range;
a filter stage configured to:
receive optical signals amplified by the first EDFA stage; and
attenuate the second wavelength range by a target amount that is less than a gain applied to the second wavelength range by the first EDFA stage, the target amount being based on an amount of gain applied by the first EDFA stage to the second wavelength range and a noise figure corresponding to the first EDFA stage; and
a second EDFA stage configured to:
receive the optical signals after the optical signals have passed through the filter stage; and
amplify the first wavelength range, the second wavelength range, and the third wavelength range.

19. The EDFA of claim 18, wherein the filter stage includes an optical filter configured to:
attenuate the first wavelength range by no more than a threshold amount; and
attenuate the second wavelength range and the third wavelength range.

20. The EDFA of claim 19, wherein:
the optical filter is further configured to:
receive a first optical signal corresponding to the first wavelength range; and
receive a second optical signal corresponding to the second wavelength range; and
the filter stage includes a bypass path configured to:
receive a third optical signal corresponding to the third wavelength range; and
bypass the optical filter such that the third optical signal avoids passing through the optical filter.
